(19) United States
(12) Patent Application Publication
(10) Pub. No.: US 2002/0163871 A1
(43) Pub. Date: Nov. 7, 2002

(54) Disk cartridge and optical disk read/write device

(76) Inventor: Mitsunobu Yoshida, Tenri-shi (JP)

Correspondence Address: Dike, Bronstein, Roberts & Cushman, Intellectual Property Practice Group, Edwards & Angell, LLP, P.O. Box 9169, Boston, MA, 02209, US

(21) Appl. No.: 10/036,065

(22) Filed: Oct. 19, 2001

(30) Foreign Application Priority Data
Oct. 20, 2000 (JP) 2000-321732
Jan. 17, 2001 (JP) 2001-9526

(51) Int. Cl. G11B 33/02; G11B 23/03

(52) U.S. Cl. 369/77.2; 369/291

(57) ABSTRACT

A disk cartridge includes: a lever engagement recess for engaging with a shutter lock engagement bump of a shutter near a side face of the optical disk read/write device; a lever section which rotates around a rotation support point which is located closer to a middle front part of the cartridge in terms of the insertion direction than is the lever engagement recess; and a pressing spring, rooted at the lever section, opposite to the lever engagement recess, between the lever engagement recess and the rotation support point to extend towards and past the rotation support point, for pressing the lever section to apply thereto a rotational force in such a direction that the lever section can engage with the shutter. The arrangement keeps small the stress of the spring section of the lock member and offers a disk cartridge in which the spring section can be disposed in small space on a triangular corner of the cartridge.

### FIELD OF THE INVENTION

The present invention relates to a disk cartridge containing an arbitrary magneto-optical storage medium, such as an optical disk or a magneto-optical disk, and an optical disk read/write device for reading/writing data on the disk cartridge, and in particular, to miniaturization of a shutter lock mechanism and a shutter unlock mechanism for a disk cartridge.

### BACKGROUND OF THE INVENTION

A conventional optical disk read/write device, as shown in FIG. 11(a)-11(c), is equipped with a cartridge holder 126 to support and load a cartridge 102 of a disk cartridge inserted into a main chassis 103.

The cartridge 102 of the disk cartridge, as shown in FIGS. 12(a)-12(c), contains a magneto-optical disk 101 so that the disk 101 is rotatable, and is equipped with a shutter 147 to open/close a first window 141 to allow access to the magneto-optical disk 101. The shutter 147 has a lock lever 154 which prevents the shutter 147 from opening when the disk cartridge is not loaded in an optical disk read/write device.

Referring to FIGS. 13(a) and 13(b), the cartridge holder 126 is shaped like a container and has, at the front, an opening through which the cartridge 102 is inserted. Rotation support points 131 around which the cartridge holder 126 is rotatable are formed on both side faces of the cartridge holder 126 near the back. As the cartridge holder 126 is rotated around the rotation support points 131, the cartridge holder 126 opens/closes at the front to allow loading/unloading of the cartridge 102 into/from the optical disk read/write device.

The following will describe an operation to insert the cartridge 102 into the cartridge holder 126 in the optical disk read/write device structured as above.

As shown in FIGS. 13(a) and 13(b), to insert the cartridge 102 into the cartridge holder 126, the cartridge holder 126 is rotated around the rotation support points 131 so that the holder 126 is lifted up from the main chassis 103. The cartridge holder 126 has a resilient shutter mover 129, and the shutter mover 129 has at the front (lower end in the figure) thereof a shutter-moving protuberance 130 bulging inwards. As the shutter-moving protuberance 130 comes into contact with a side face of the cartridge 102, the protuberance 130 is pushed by a perpendicular surface 149 of the shutter 147 as shown in FIG. 14(a) and climbs and slides on the perpendicular surface 149 as shown in FIG. 14(b).

Then, as shown in FIG. 15, an unlocking member 127 provided to the cartridge holder 126 comes into contact with a lock lever 154 provided to the cartridge 102, and as a result, a shutter lock section 153 of the shutter 147 disengages from a lock lever engagement section 155 of the lock lever 154. So does the shutter 47 from the lock lever 154. As soon as the unlocking member 127 comes into contact with the front (in terms of the insertion direction) of the shutter lock section 153 of the shutter 147, the shutter-moving protuberance 130 of the shutter mover 129 moves into a shutter window section 150 carved out on the perpendicular surface 149 because of resilient force and holds the shutter 147 in a predetermined position on the cartridge holder 126.

By pushing the cartridge 102 further, the cartridge 102 is inserted further inwards; the shutter 147 is however held stationary, and the shutter 147 opens due to the relative movement.

Conversely, to close the shutter 147 for removal of the cartridge 102, the cartridge 102 is pulled oppositely to the insertion. However, since the shutter-moving protuberance 130 is caught in the shutter window section 150, the shutter 147 does not move. When the shutter 147 has shut the first window 141 of the cartridge 102, the lock lever 154 locks the shutter 147 as a result of the unlocking member 127 moves away from the shutter 147. See FIG. 14(b). Thereafter, the shutter-moving protuberance 130 moves out of the shutter window section 150 of the shutter 147 before the cartridge 102 is completely pulled out of the cartridge holder 126. See FIGS. 14(a), 13(a), and 13(b).

Now, a detailed description is given here about the lock lever 154 in the cartridge 102.

As shown in FIG. 14(a), a conventional lock lever 154 is disposed in the cartridge 102, on a corner where the unlocking member 127 of the cartridge holder 126 is inserted, so as to turn around the turn support point 158. The lock lever 154 is built integrally with a lever section 156 and a spring section 157. The lever section 156 extends from the turn support point 158, and the spring section 157 extends from the turn support point 158 and presses the lever section 156 so that the lever section 156 can engage with the shutter lock section 153.

The lever section 156 is provided with a lock lever engagement section 155 for engaging with the shutter lock section 153 of the shutter 147 as shown in FIGS. 13(a) and 13(b). When the lock lever engagement section 155 engages with the shutter lock section 153 as shown in FIGS. 14(a) and 14(b), the spring section 159 is mounted to the lock lever 154, being displaced by a predetermined angle from a no-load position to press the lock lever 154. While the unlocking member 127 is preventing the lock lever 154 from engaging with the shutter lock section 153 as shown in FIG. 15, the spring section 159 is under load that is equivalent to the angular displacement of the lock lever 154.

As mentioned earlier, the spring section 159 of the lock lever 154 is under load that is equal to a sum of a predetermined initial load developing when the lock lever 154 is engaged with the shutter lock section 153 and a load developing when the lock lever 154 is freed from the engagement. Consequently, if the spring section 159 is short, the stress is heavy; to keep the stress sufficiently small, the spring section 159 must be sufficiently long.

Nevertheless, it is impossible to set aside enough space to allow for a sufficiently long spring section 159 in conventional disk cartridges, such as a cartridge 202 shown in FIGS. 16(a), 16(b), 17(a), and 17(b); the cartridge 202 has a notch (not shown) at the front and a positioning hole 261 near the front, both in terms of the insertion direction, to secure an enough angle to mount a magnetic head in such a manner to couple the magnetic head to a pickup unit (neither shown).

Specifically, if a conventional lock lever 154 is to be used in the cartridge 202, there is no other choice, but to find space to mount the lock lever 154 on the substantially triangular corner near the front of the cartridge 202 in terms of the insertion direction, as shown in FIGS. 16(a), 16(b). The space is taken up by the need to give enough room for the lever section 156 of the lock lever 154 to turn (be displaced), which places limits on the length of the spring section 159. Further, as shown in FIGS. 17(a) and 17(b), the spring section 159 must be short likewise when the spring section 159 is disposed sideways from the turn support point 158 to secure sufficient room for the lever section 156 to turn. As shown in FIGS. 17(a) and 17(b), the presence of the positioning hole 261 on the cartridge 202 places especially greater limits.

The conventional disk cartridge and optical disk read/write device has other problems too. As shown in FIG. 18(a), the lock lever 154 of the cartridge 102 has a slanting section 157 where the lock lever 154 comes in contact with the unlocking member 127 of the cartridge holder 126, and the shutter 147 is unlocked at a variable position.

Considering dimensional tolerance and distortion due to wear of the cartridge 102 and the cartridge holder 126, the cartridge holder 126 is made slightly larger than the cartridge 102. Other parts also have dimensional tolerance of their own. The relative positions of the cartridge holder 126 and the cartridge 102 therefore can vary depending upon combinations of the parts as indicated by distance A in FIG. 18(a) and distance A′ in FIG. 18(b).

The lock lever 154 disengages from the shutter 147 when the unlocking member 127 is pushed in a little after coming in contact with the lock lever slanting section 157. The unlocking member 127 comes into contact with the lock lever slanting section 157 at a relative position which can vary. For these reasons, the unlocking timing varies by an amount equivalent to distance B as shown in FIGS. 18(a) and 18(b).

As a result, even if the shutter-moving protuberance 130 is designed to be released from the lock lever 154 when the shutter-moving protuberance 130 of the shutter mover 129 enters the shutter window section 150, the unlocking may occur earlier than the designed timing as shown in FIG. 18(b). If the lock lever 154 is released before the shutter-moving protuberance 130 enters the shutter window section 150, problems develop where the shutter-moving protuberance 130 slides on the perpendicular surface 149 of the shutter 147 and the shutter 147 will not open.

### SUMMARY OF THE INVENTION

The present invention has a first objective to offer a disk cartridge with a spring section mounted on a small, triangular corner in the cartridge, whereby the stress of the spring section of the lock member can be kept low.

A disk cartridge in accordance with the present invention, in order to achieve the objective, is characterized in that it includes:

a disk for storing data;

a cartridge for containing the disk in a rotatable manner, complete with a read/write window through which read/write means of an optical disk read/write device makes internal access;

a shutter which, when the cartridge is inserted into the optical disk read/write device and the read/write window is opened, slides on the cartridge in a direction opposite to a direction of the insertion as a result of the insertion; and

a lock member for engaging with the shutter to prevent the shutter from moving when the shutter is closed and disengaging from the shutter as a result of the insertion of the cartridge;

wherein

the lock member includes:

an engagement section for engaging with the shutter near a side face of the cartridge;

a lever section which rotates around a rotation support point which is located closer to a middle front part of the cartridge in terms of the direction of the insertion than is the engagement section; and

a spring section, rooted at the lever section, opposite the engagement section, between the engagement section and the rotation support point to extend towards and past the rotation support point, for pressing the lever section to apply thereto a rotational force in such a direction that the lever section can engage with the shutter.

In the invention, the spring section is rooted at the lever section, opposite the engagement section, between the engagement section and the rotation support point to extend towards and past the rotation support point. An end of the spring section presses a substantially central part of the lever section and can apply a rotational moment to the lever section efficiently, compared to pressing the lever section near the rotation support point.

Extending past the rotation support point at the other end, the spring section has an extended length compared to a spring section extending only up to the rotation support point of the lever section. This allows for a reduced spring coefficient and a reduced stress of the spring section when the lever section rotates and releases the shutter.

Consequently, a disk cartridge can be offered in which the stress of the spring section of the lock member can be kept small and the spring section can be mounted in small space on a triangular corner of the cartridge.

Another disk cartridge in accordance with the present invention, in order to achieve the objective, is characterized in that it includes:

a disk for storing data;

a cartridge for containing the disk in a rotatable manner, complete with a read/write window through which read/write means of an optical disk read/write device makes internal access;

a shutter which, when the cartridge is inserted into the optical disk read/write device and the read/write window is opened, slides on the cartridge in a direction opposite to a direction of the insertion as a result of the insertion; and

a lock member for engaging with the shutter to prevent the shutter from moving when the shutter is closed and disengaging from the shutter as a result of the insertion of the cartridge;

wherein

the lock member includes:

an engagement section for engaging with the shutter near a side face of the cartridge;

a lever section which rotates around a rotation support point which is located closer to a middle front part of the cartridge in terms of the direction of the insertion than is the engagement section; and

a spring section for pressing the lever section to apply thereto a rotational force in such a direction that the lever section can engage with the shutter, the spring section being adapted so that a pressing force applied to the lever section by the spring section as a result of the lock member being released from the engagement with the shutter is smaller than a pressing force applied as a result of a change in an angle between the spring section and the lever section, the change being equal to an angle by which the lock member is displaced when the lock member is released from the engagement.

Consequently, the pressing stress, and hence the tension, of the pressing section when the lever section is not engaged with the shutter are smaller than those in conventional cases.

The present invention has a second objective to offer a disk cartridge and an optical disk read/write device which ensures, regardless of the insertion condition of the cartridge, that the shutter is unlocked and the shutter is opened/closed appropriately.

Another disk cartridge in accordance with the present invention, in order to achieve the objective, is characterized in that it includes:

a disk for storing data;

a cartridge for containing the disk in a rotatable manner, complete with a read/write window through which read/write means of an optical disk read/write device makes internal access;

a shutter which slides parallel to a direction of insertion of the cartridge into the optical disk read/write device to open/close the read/write window; and

a lock member for engaging with the shutter to prevent the shutter from moving when the shutter is closed and rotating around a rotation support point provided inside a cartridge-side groove formed on a side face of the cartridge near a front of the cartridge in terms of the direction of insertion,

wherein

the lock member of the cartridge is provided facing inwards on a side face of a cartridge holder in the optical disk read/write device and is adapted so that a contact surface where the lock member contacts an unlocking member for releasing the lock member from the engagement with the shutter when the cartridge is inserted has a perpendicular surface in the direction of the insertion of the cartridge.

In the invention, the disk cartridge includes:

a disk for storing data;

a cartridge for containing the disk in a rotatable manner, complete with a read/write window through which read/write means of an optical disk read/write device makes internal access;

a shutter which slides parallel to a direction of insertion of the cartridge into the optical disk read/write device to open/close the read/write window; and

a lock member for engaging with the shutter to prevent the shutter from moving when the shutter is closed and rotating around a rotation support point provided inside a cartridge-side groove formed on a side face of the cartridge near a front of the cartridge in terms of the direction of insertion.

Further, in the invention, a feature arrangement is made in which the lock member of the cartridge is provided facing inwards on a side face of a cartridge holder in the optical disk read/write device and is adapted so that a contact surface where the lock member contacts an unlocking member for releasing the lock member from the engagement with the shutter when the cartridge is inserted has a perpendicular surface in the direction of the insertion of the cartridge.

In conventional cases, if the relative positions of the cartridge and the unlocking member of the cartridge holder in a direction perpendicular to the insertion direction of the cartridge varies, the timing to unlock the shutter also varies due to the slanting contact surface between the lock member and the unlocking member, causing the shutter fail to open. In contrast, in the present invention, the contact surface between the lock member and the unlocking member is provided with a face perpendicular to the insertion direction of the cartridge, and the shutter therefore is unlocked at a substantially invariable timing.

Consequently, a disk cartridge can be offered which ensures, regardless of the insertion condition of the cartridge, that the shutter is unlocked and the shutter is opened/closed appropriately.

Another disk cartridge in accordance with the present invention, in order to achieve the objective, is characterized in that a part of the unlocking member where the unlocking member contacts the lock member is provided substantially parallel to the contact surface of the lock member to load the disk cartridge.

This ensures that the unlocking member contacts the lock member perpendicularly to the insertion direction of the cartridge. Consequently, an optical disk read/write device can be offered which ensures, regardless of the insertion condition of the cartridge, that the shutter is unlocked and the shutter is opened/closed appropriately.

For a fuller understanding of the nature and advantages of the invention, reference should be made to the ensuing detailed description taken in conjunction with the accompanying drawings.

### BRIEF DESCRIPTION OF THE DRAWINGS

FIGS. 1(a) and 1(b) show an embodiment of a disk cartridge in accordance with the present invention,

FIG. 1(a) being constituted by an illustrative view of a major part showing a shutter lock engagement bump interlocking with a lever engagement recess on a lever section of a lock lever, and

FIG. 1(b) by an illustrative view of a major part showing the shutter in no engagement with the lever section.

FIGS. 2(a), 2(b), and 2(c) show the disk cartridge,

FIG. 2(a) being constituted by a top view,

FIG. 2(b) by a side view, and

FIG. 2(c) by a rear view.

FIGS. 3(a) and 3(b) show the disk cartridge being loaded in an optical disk read/write device,

FIG. 3(a) being constituted by a top view,

FIG. 3(b) by a side view, and

FIG. 3(c) by a rear view.

FIGS. 4(a) and 4(b) show the disk cartridge about to be loaded in a cartridge holder of an optical disk read/write device,

FIG. 4(a) being constituted by a top view,

FIG. 4(b) by a side view.

FIG. 5(a) is an illustrative view in a cartridge showing a lever section under no load from a pressing spring, and

FIG. 5(b) is an illustrative view showing the lever section under an initial pressing force from the pressing spring.

FIG. 6(a) is an illustrative view showing the lever section having been turned by a rotation angle B from the position shown in FIG. 5(b), and

FIG. 6(b) is an illustrative view showing virtual positions of a pressing spring exerting a pressing force equivalent to the rotation angle B.

FIG. 7(a) is an illustrative view showing positions of a pressing spring exerting a pressing force equivalent to a rotation angle C in the context of FIG. 6(b), and

FIG. 7(b) is an illustrative view showing how the lever section is engaged at that time.

FIG. 8 shows another embodiment in accordance with the present invention and is constituted by an illustrative view of a major part showing an arrangement of a lock lever in a disk cartridge and an unlocking member in a cartridge holder.

FIGS. 9(a) and 9(b) depict an operation of a lock lever in the disk cartridge and an unlocking member in the cartridge holder,

FIG. 9(a) being constituted by an illustrative view showing a shutter-moving protuberance is caught in a side groove at an early stage in the inserting of a cartridge into a cartridge holder, and

FIG. 9(b) by an illustrative view showing the shutter-moving protuberance sliding onto a perpendicular surface of the shutter as a result of the cartridge being inserted deeper into the cartridge holder.

FIGS. 10(a) and 10(b) are illustrative views of a major part showing an unlocking member in contact with a lock lever,

FIG. 10(a) showing a case where there is a large gap between the cartridge and the cartridge holder,

FIG. 10(b) where there is a small gap between the cartridge and the cartridge holder.

FIGS. 11(a), 11(b), and 11(c) show an arrangement of a conventional optical disk read/write device,

FIG. 11(a) being constituted by a top view,

FIG. 11(b) by a side view,

and FIG. 11(c) by a rear view.

FIGS. 12(a), 12(b), and 12(c) show a disk cartridge loaded in the optical disk read/write device,

FIG. 12(a) being constituted by a top view,

FIG. 12(b) by a side view,

FIG. 12(c) by a rear view.

FIGS. 13(a) and 13(b) depict how the disk cartridge is loaded into a cartridge holder of an optical disk read/write device,

FIG. 13(a) being constituted by a top view, and

FIG. 13(b) by a side view.

FIGS. 14(a) and 14(b) depict an operation of a lock lever in the disk cartridge and an unlocking member in the cartridge holder,

FIG. 14(a) being constituted by an illustrative view of a major part showing a shutter-moving protuberance is caught in a side groove at an early stage in the inserting of a cartridge into a cartridge holder, and

FIG. 14(b) by an illustrative view of a major part showing how the shutter-moving protuberance slides onto a perpendicular surface of a shutter as a result of the cartridge being inserted deeper into the cartridge holder.

FIG. 15 depicts an operation of a lock lever in the disk cartridge and an unlocking member in the cartridge holder, constituted by an illustrative view of a major part showing an unlocking member in contact with a lock lever.

FIGS. 16(a) and 16(b) depict another conventional disk cartridge,

FIG. 16(a) being constituted by an illustrative view of a major part showing a lever section being caught in a shutter of a cartridge having a positioning hole near the front in terms of the insertion direction, and

FIG. 16(b) by an illustrative view of a major part showing the lever section in no engagement with the shutter.

FIGS. 17(a) and 17(b) depict still another conventional disk cartridge,

FIG. 17(a) being constituted by an illustrative view of a major part showing a lever section being caught in a shutter of a cartridge having a positioning hole near the front in terms of the insertion direction, and

FIG. 17(b) by an illustrative view of a major part showing the lever section in no engagement with the shutter.

FIGS. 18(a) and 18(b) depict yet another conventional disk cartridge as to an operation of a lock lever in the disk cartridge and an unlocking member in the cartridge holder,

FIG. 18(a) being constituted by an illustrative view of a major part showing an unlocking member in contact with a lock lever when there is a large gap between a cartridge and a cartridge holder, and

FIG. 18(b) when there is a small gap between a cartridge and a cartridge holder.

### DESCRIPTION OF THE EMBODIMENTS

[Embodiment 1]

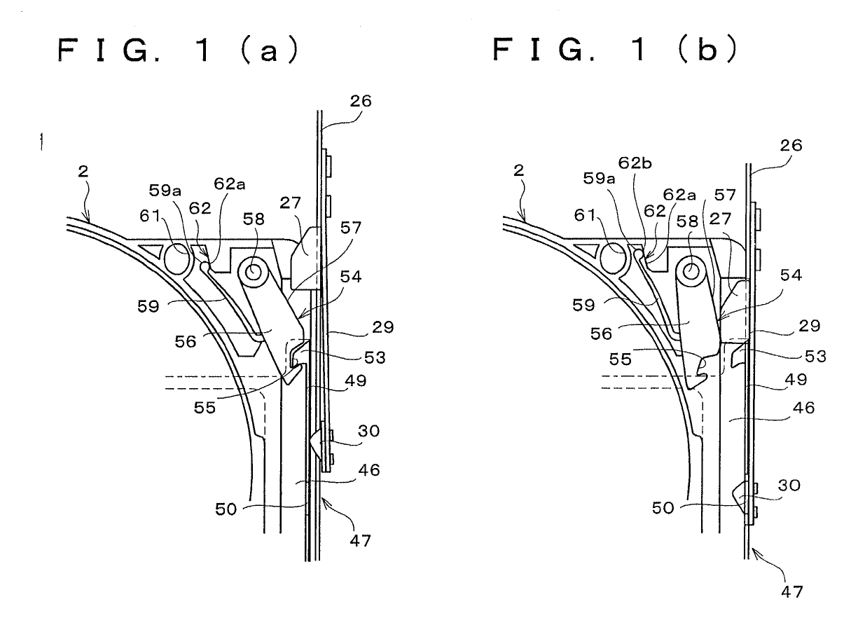

The following will describe an embodiment in accordance with the present invention in reference to FIGS. 1-7.

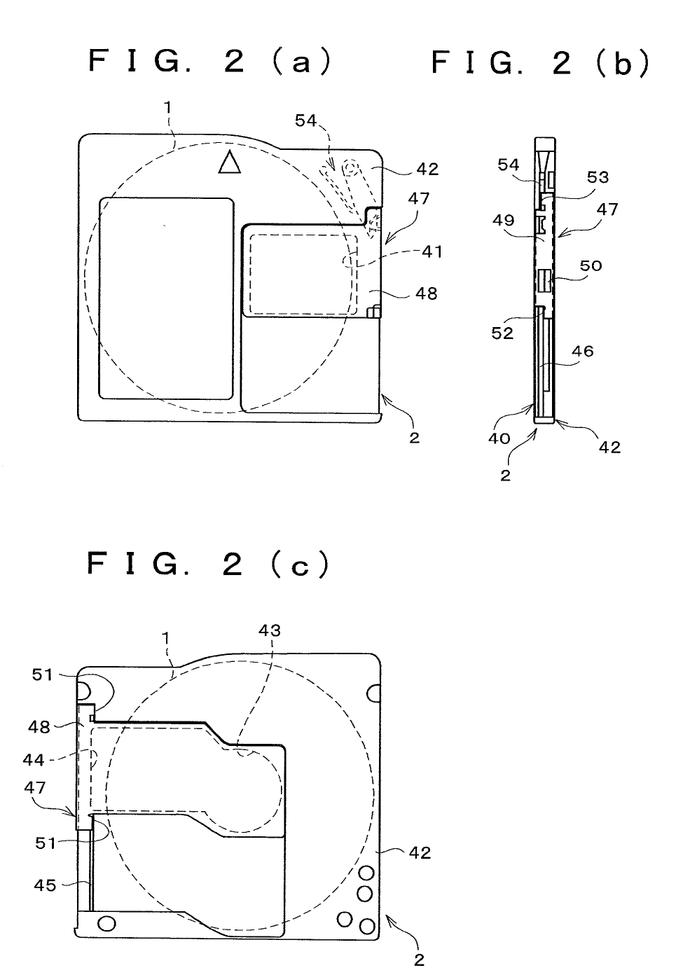

A disk cartridge loaded into a magneto-optical disk read/write device of the present embodiment includes a shutter 47 and a cartridge 2 formed by an upper shell 40 and a lower shell 42, as shown in FIGS. 2(a)-2(c). The cartridge 2 contains therein a data storage magneto-optical disk 1 in such a manner to allow the disk 1 to rotatable.

The upper shell 40 has a first window 41 through which a magnetic head 12 (detailed later) as read/write means for reading/writing data makes internal access. The lower shell 42 has a second window 43 positioned opposite a spindle motor 4 (detailed later) to support the magneto-optical disk 1 for rotation and a third window 44 through which a pickup unit (detailed later) 7 as read/write means for reading/writing data makes internal access. The first window 41, the second window 43, and the third window 44 each function as a read/write window in accordance with the present invention.

The shutter 47 includes: upper and lower shutter parts 48 for covering the first window 41, the second window 43, and the third window 44; a perpendicular surface 49 for linking the upper and lower shutter parts 48; a shutter tabs 51 for guiding and preventing the shutter 47 from coming off in opening/closing; a shutter guiding section 52 for sliding the cartridge 2; and a shutter lock engagement bump 53 (see FIG. 1(a) and later description for more detail) which interlocks with a lever engagement recess (engagement section) 55 formed on a lock lever (lock member) 54 which will be described in detail later.

As shown in FIG. 2(c), the shutter tabs 51 are disposed so as to slide in engagement with a guiding groove 45 formed on the lower shell 42 and has purposes of preventing the shutter 47 from coming off the cartridge 2 and guiding the shutter in sliding. Referring to FIG. 2(b), the shutter 47 is supported in the thickness direction of the cartridge 2 by the interior of the upper and lower shutter parts 48, the exterior of the shutter sliding part of the cartridge 2, and the shutter guiding section 52 disposed opposite one of the shutter tabs 51 at the rear part of the shutter 47 in terms of the insertion direction (lower part in the figure).

Still referring to FIG. 2(b), on a side face of the cartridge 2 on which the perpendicular surface 49 slides is there provided a cartridge-side groove 46 through which a shutter unlocking member 27 of a cartridge holder 26 (detailed later) passes. The lock lever 54 is visible at the front in terms of the insertion direction.

The shutter 47, when closed, has the shutter lock engagement bump 53 interlocking with the lever engagement recess 55 on a lever section 56 (detailed later) of the lock lever 54. See FIG. 1(a) and later description for more detail. When inserting the cartridge 2, the shutter 47 gradually unlocks itself from the recess 55 as will be detailed later as the entire cartridge 2 is loaded into the magneto-optical disk read/write device to allow access to data.

Now, the following will describe a magneto-optical disk read/write device.

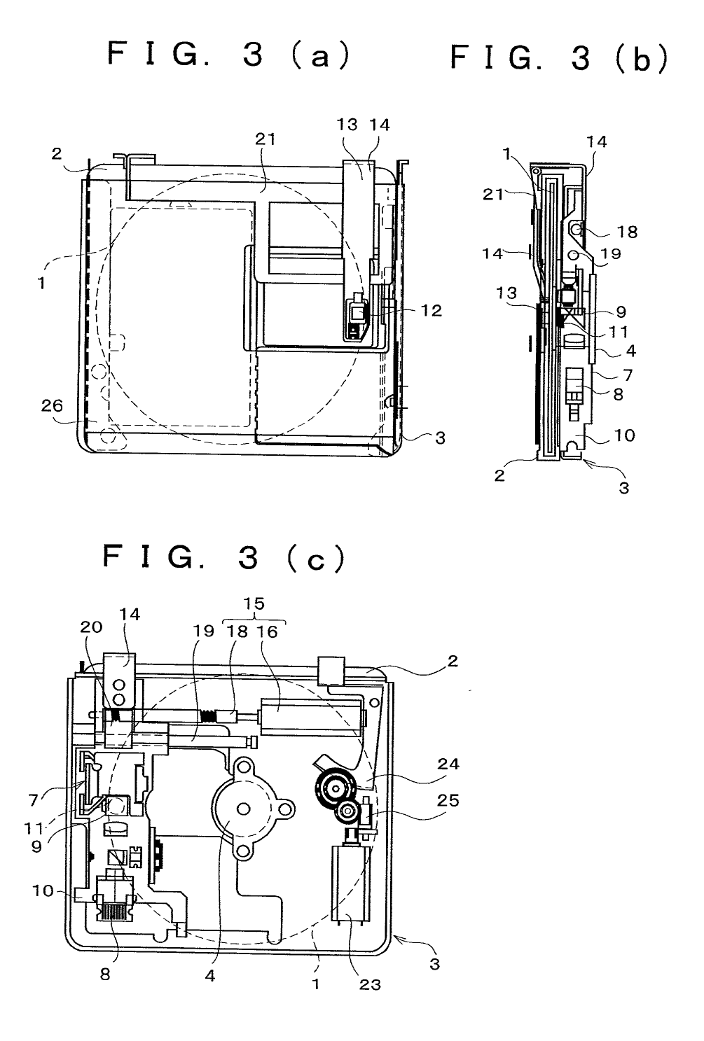

Referring to FIGS. 3(a)-3(c), a magneto-optical disk read/write device of the present embodiment has a spindle motor 4 practically at the center of the main chassis 3 and chucks the magneto-optical disk 1 with a hub (not shown) on top of the spindle motor axis projecting from the main chassis 3 to rotate the disk 1 at a predetermined rotation speed during data reading/writing.

A pickup unit 7 and a magnetic head 12 are located opposite to each other across the magneto-optical disk 1.

The pickup unit 7 is adapted so as to reflect a laser emitted by a laser light source 8 at a prism 9 or mirror in a direction normal to the magneto-optical disk 1 and then focus the reflected laser with an objective lens 11 on a storage layer in the magneto-optical disk 1.

The pickup unit 7 is structured to be slid by a slide mechanism 15 in a radial direction of the magneto-optical disk 1 on a guiding axis 19 which is secured on the main chassis 3 in a direction perpendicular to the spindle motor 4.

The slide mechanism 15 is chiefly composed of a sliding motor 16 and a sliding screw 18. As the sliding motor 16 rotates, the sliding screw 18 rotates, and the pickup unit 7 interlocking with the sliding screw 18 slides in a radial direction of the magneto-optical disk 1.

To interlock the pickup unit 7 with the sliding screw 18, a resilient component 20, called a grip spring, is secured at one end to the pickup unit 7 and pressed at the other end to the sliding screw 18. Thus, the pickup unit 7 can reciprocate on the guiding axis 19 with no backlash. The grip spring 20 can smoothly convey rotational force the sliding motor 16 exerts on the pickup unit 7. Also, the grip spring 20 can deform and move onto the sliding screw 18 to avoid clash with the rotating sliding motor 16 when the pickup unit 7 receives a shock force or moves beyond a stopper.

The magnetic head 12 in FIG. 3(a) is formed by windings inserted to surround a core made integrally of ferrite. The magnetic head 12 is secured to a suspension 13 which has a resilient structure exerting a force normal to the magneto-optical disk 1, and the suspension 13 is secured to a head supporting angle 14. The head supporting angle 14, as shown in FIGS. 3(b) and 3(c), is secured to a housing 10 for the pickup unit 7, while being positioned by means of the magnetic head 12 and a spot made by focusing of the objective lens 11.

Thus, when the pickup unit 7 is slid by the slide mechanism 15 in a radial direction of the magneto-optical disk 1, the magnetic head 12 secured to the housing 10 is slid together.

The magnetic head 12 is pressed against the disk surface to write data and distanced from the disk surface by a magnetic head lifting/lowering mechanism lifting the magnetic head 12 to read data or eject the magneto-optical disk 1.

The magnetic head lifting/lowering mechanism is formed, as shown in FIG. 3(c), by a head lifting/lowering motor 23 and a decelerating mechanism 25 both located on the bottom of the main chassis 3, a rotation lever 24 driven by the head lifting/lowering motor 23 and the decelerating mechanism 25, and a head lifting/lowering lever 21 interposed between the magnetic head 12, the suspension 13, and the cartridge 2 so as to be freely rotatable as shown in FIG. 3(a) and FIG. 3(b).

In the magnetic head lifting/lowering mechanism, the head lifting/lowering motor 23 produces a rotational force which is conveyed by the decelerating mechanism 25 to the rotation lever 24. The rotation lever 24 rotates the head lifting/lowering lever 21 to separate the suspension 13 and the magnetic head 12 from the magneto-optical disk 1 by a predetermined distance. Usually, the head lifting/lowering lever 21 is disposed above the cartridge 2, whereas the driving section to operate the head lifting/lowering lever 21 is disposed below the main chassis 3. The upper and lower parts are linked from the outer circumference of the cartridge 2 by a control section for the rotation lever 24 and the head lifting/lowering lever 21.

To write data on the magneto-optical disk 1, the magneto-optical disk 1 is rotated by the spindle motor 4 at a predetermined rotation speed, and the magnetic head 12 is lowered by the head lifting/lowering mechanism to be pressed by the suspension 13 against the disk surface, and the pickup unit 7 emits a laser onto the storage layer in the magneto-optical disk 1. As a result, the storage layer (not shown) is partially heated where it is irradiated with the laser and changes its magnetization in accordance with an external magnetic field. Data is written as magnetization-direction-inverted regions formed in the storage layer in a predetermined pattern by magnetic field modulation whereby the external magnetic field alters in accordance with a recording signal.

To read data from the magneto-optical disk 1, the magnetic head 12 lifting/lowering mechanism moves the suspension 13 and the magnetic head 12 away from the magneto-optical disk 1 to separate by a predetermined distance. Data is now read by means of a laser.

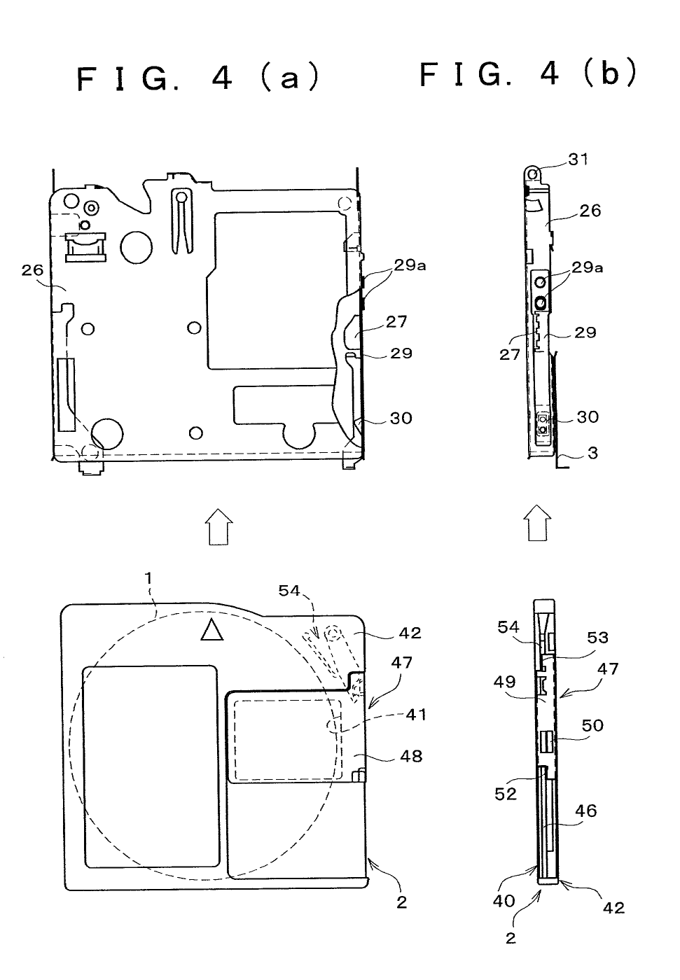

The following will describe a mechanism to load the cartridge 2 into the magneto-optical disk read/write device in reference to FIGS. 4(a), 4(b), 1(a) and 1(b).

As shown in FIGS. 4(a) and 4(b), the main chassis 3 is equipped with a cartridge holder 26 which holds the inserted cartridge 2 for proper loading. The cartridge holder 26 is shaped like a container and has, at the front end, an opening through which the cartridge 2 is inserted. Rotation support points 31 around which the cartridge holder 26 is rotatable are formed on both side faces of the cartridge holder 26 near the back. As the cartridge holder 26 is rotated around the rotation support points 31, the cartridge holder 26 opens/closes at the front to allow loading/unloading of the cartridge 2 into/from the magneto-optical disk read/write device.

On the external faces of the cartridge holder 26 is there provided a shutter mover 29 composed of a plate spring extending along the side face, to open/close the shutter 47 of the cartridge 2. The shutter mover 29 is secured to the cartridge holder 26 at shutter mover attaching sections 29a which are located practically in the center of the cartridge holder 26 in terms of the insertion direction of the cartridge 2. The shutter mover 29 has, at the front (below the cartridge holder 26 in the figure), a shutter-moving protuberance 30 projecting inwards in terms of the insertion direction of the cartridge 2. The protuberance 30 is shaped like a substantially triangular plate. The part of the cartridge holder 26 where the shutter-moving protuberance 30 thrusts has an opening to allow the thrusting movement.

When the cartridge 2 inserted in the cartridge holder 26, the shutter-moving protuberance 30 comes in contact with a side face of the cartridge holder 26. As the cartridge 2 is pushed deeper inside, since the shutter mover 29 is made from a plate spring, the shutter-moving protuberance 30 moves and slides on a side face of the cartridge 2. Under these conditions, the shutter mover 29 bends away from the cartridge holder 26. As the cartridge 2 is pushed deeper, as shown in FIG. 1(a), the shutter-moving protuberance 30 moves onto the perpendicular surface 49 of the shutter 47 of the cartridge 2.

Referring to FIGS. 4(a) and 4(b), at a practical center of the cartridge holder 26 in terms of the insertion direction of the cartridge 2 and somewhat closer to the front than the shutter mover attaching sections 29a in terms of the insertion direction of the cartridge 2, the unlocking member 27 shaped like a plate is provided toward the inside of the cartridge holder 26. The unlocking member 27 is also adapted to engage with a cartridge-side groove 46 on a side face of the cartridge 2 and thereby acts as a guide in the inserting of the cartridge 2 when the cartridge 2 is inserted into the cartridge holder 26. As shown in FIG. 1(b), the unlocking member 27 is further adapted to open the shutter 47 as the member 27, in inserting the cartridge 2, comes in contact with, and thus is pressed against, the lock lever 54 formed on the cartridge 2, rotates the lock lever 54 around the rotation support point 58 against a pressing spring (spring section) 59, and disengages the shutter lock engagement bump 53 from the lever engagement recess 55.

The following will describe the outline of an operation of the lock lever 54 to insert the cartridge 2 into the cartridge holder 26.

Referring to FIGS. 4(a) and 4(b), the cartridge 2 is inserted with the cartridge holder 26 lifted from the main chassis 3. In this case, as shown in FIG. 1(a), first, the shutter-moving protuberance 30 disposed at the front end, in terms of the insertion direction, of the resilient shutter mover 29 which is provided to the cartridge holder 26 to open/close the shutter 47 moves onto a side face of the cartridge 2 and then moves and slides on the perpendicular surface 49 of the shutter 47.

Thereafter, as shown in FIG. 1(b), the unlocking member 27 formed on the cartridge holder 26 comes into contact with a lock lever contact surface 57 of the lock lever 54 of the cartridge 2; thus, the lock lever 54 rotates around the rotation support point 58, and the lever engagement recess 55 of the lock lever 54 disengages from the shutter lock engagement bump 53 of the shutter 47. As the cartridge 2 is inserted deeper, the unlocking member 27 moves into contact with the front of the shutter lock engagement bump 53 of the shutter 47 in terms of the insertion direction. Almost simultaneously with the unlocking member 27 moving into contact with the shutter 47, the shutter-moving protuberance 30 disposed at the front of the shutter mover 29 in terms of the insertion direction enters, by means of a resilient force, the shutter window section 50 carved out on the perpendicular surface 49 and thus holds the shutter 47 at a predetermined part of the cartridge holder 26.

By the push operation of the cartridge 2, the cartridge 2 itself is pushed deep inside, but the shutter 47 is held in the original position; the relative movement causes the shutter 47 to open.

Conversely, to close the shutter 47, the cartridge 2 is pulled in a direction opposite to the insertion direction; the shutter 47 does not move for a while because the shutter-moving protuberance 30 is engaged with the shutter window section 50 of the shutter 47. As the shutter 47 closes the cartridge 2, the unlocking member 27 is released from the shutter 47, the lock lever 54 soon interlocks with the shutter 47, the shutter-moving protuberance 30 moves over from the shutter window section 50 of the shutter 47, and thereafter, the cartridge 2 is completely pulled out of the cartridge holder 26.

Next, the lock lever 54 of the cartridge 2, which is a feature of the present embodiment, will be described in detail in terms of mechanism.

As mentioned roughly in the foregoing, as FIGS. 1(a) and 1(b) show, the lock lever 54 has the lever section 56 extending from the rotation support point 58. Near the front of the lever section 56 is provided a lever engagement recess 55 for engaging with the shutter lock engagement bump 53 of the shutter 47. The lever section 56 is equipped with a pressing spring 59.

The lever section 56 and the pressing spring 59, constituting the lock lever 54, are fabricated as a single entity from a commercial resin. Therefore, the lock lever 54 is easy to make. Alternatively, the lever section 56 and the pressing spring 59 may be fabricated separately and connected together later.

The pressing spring 59 of the present embodiment is rooted at the lever section 56, opposite the lever engagement recess 55, between the lever engagement recess 55 and the rotation support point 58 and extends from there towards and past the rotation support point 58. The tip of the pressing spring 59 is equipped with an R-shaped protuberance 59a slides smoothly on a spring section contact wall 62 which is a regulating section, as well as a wall, of the cartridge 2 holding the protuberance 59a of the pressing spring 59. In short, in the present embodiment, the protuberance 59a provided at the tip of the pressing spring 59 is made movable. This allows for a long pressing spring 59 and thereby reduces a pressing stress when the lever section 56 is pressed.

Assuming that the pressing spring 59 is a cantilever, the stress a exerted on the mounting section of the pressing spring 59 is given by equation 1:

$$\begin{matrix}σ = M / Z \\ = W \cdot L / Z\end{matrix} \qquad ( Eq . 1 )$$

where W is the load at the tip of the pressing spring 59, L is the length of the pressing spring 59, and M is a bending moment. Under these conditions, the tip of the pressing spring 59 is displaced by δ which is given by equation 2:

δ=W·L³/(3·E·I) (Eq. 2)

where E is a vertical elastic modulus, and I is a moment of inertia of area. From Eq. 2, we obtain

W=δ·(3·E·I)/L³ (Eq. 3)

It would be understood from Eq. 3 that the load W decreases with an increase in the length L of the pressing spring 59 when the lock lever 54 is freed from engagement even if there is no change in the angular displacement. Eq. 1 shows that in such an event, the mounting section of the pressing spring 59 experiences a reduced stress a. In short, the greater the length L of the pressing spring 59, the smaller the stress σ exerted on the mounting section of the pressing spring 59.

In the present embodiment, the pressing spring 59 is adapted to press the lever section 56 with a force equivalent to a sum of an angle caused by an initial pressing force and an angle that is smaller than rotational angular displacement of the lever section 56.

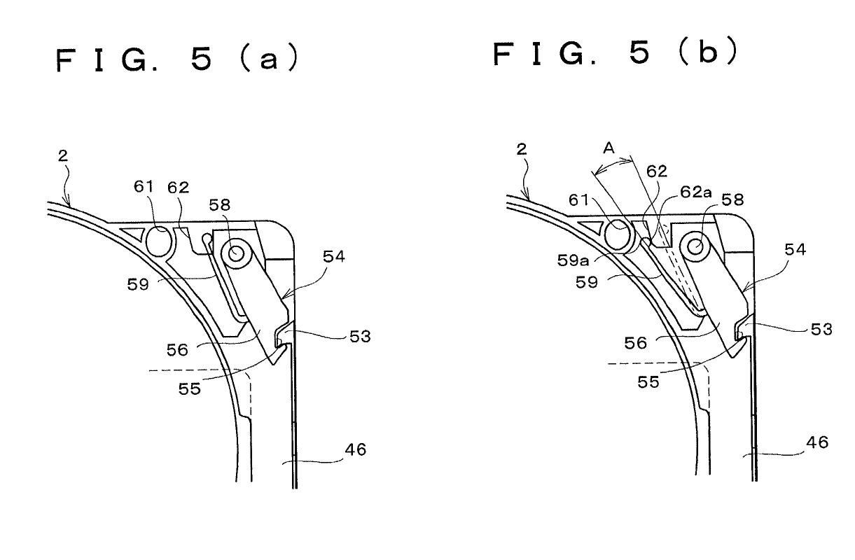

Now, referring to FIGS. 5(a)-7(b), the following will describe in detail why the pressing spring 59 is formed in this manner.

Referring first to FIG. 5(a), the pressing spring 59 is substantially parallel to the lever section 56, when the shutter lock engagement bump 53 is caught in the lever engagement recess 55 on the lever section 56 of the lock lever 54 and the pressing spring 59 is not displaced at all. In this situation, the pressing spring 59 applies no pressing force at all to the lever section 56. FIG. 5(b) shows an initial pressing condition in which the pressing spring 59 is displaced from the no-displacement condition by an initial angle A so that the pressing spring 59 experience a predetermined load. If the pressing spring 59 is applying no pressing force at all to the lever section 56 as shown in FIG. 5(a), there is likelihood of the lever section 56 being easily rotated and the shutter lock engagement bump 53 being easily released from the engagement with the lever engagement recess 55 on the lever section 56. To prevent from this happening, the initial condition must involve a pressing force which is large enough to prevent the shutter lock engagement bump 53 from moving out of the lever engagement recess 55 on the lever section 56 too easily. To this end, the initial angle A is such an angular displacement of the pressing spring 59 to produce that initial pressing force.

Further, in the present embodiment, as shown in FIG. 5(b), the spring section contact wall 62 of the cartridge 2 is adapted so that when the lever section 56 is engaged with the shutter lock engagement bump 53, the protuberance 59a of the pressing spring 59 can remain in a position 62a whereby the initial angle A is maintained.

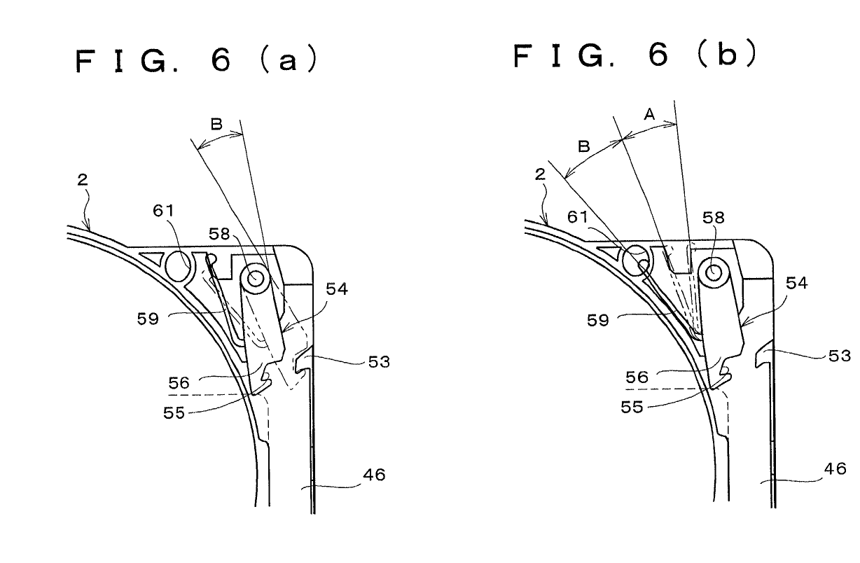

Next, to release the shutter lock engagement bump 53 from the lever engagement recess 55 under the condition shown in FIG. 5(b), the lever section 56 is rotated by a rotation angle B as shown in FIG. 6(a). Here, the angle of the pressing spring 59 with respect to the lever section 56 is depicted to be equal to the initial angle A shown in FIG. 5(b). Incidentally, the pressing spring 59 actually experiences a pressing force equivalent to the rotation angle B of the lever section 56. Accordingly, taking into consideration the pressing force equivalent to the rotation angle B of the lever section 56 as well as the initial pressing force, the pressing spring 59 is positioned, as shown in FIG. 6(b), at a sum of the initial angle A and the rotation angle B with respect to the lever section 56. The pressing spring 59 positioned at the sum angle applies the same pressing force to the lever section 56 as in a conventional case when the shutter lock engagement bump 53 is not engaged with the lever section 56.

Nevertheless, if a pressing force equivalent to the rotation angle B is applied to the pressing spring 59, the lever section 56 receives too strong a pressing stress when in no engagement, which is not suitable.

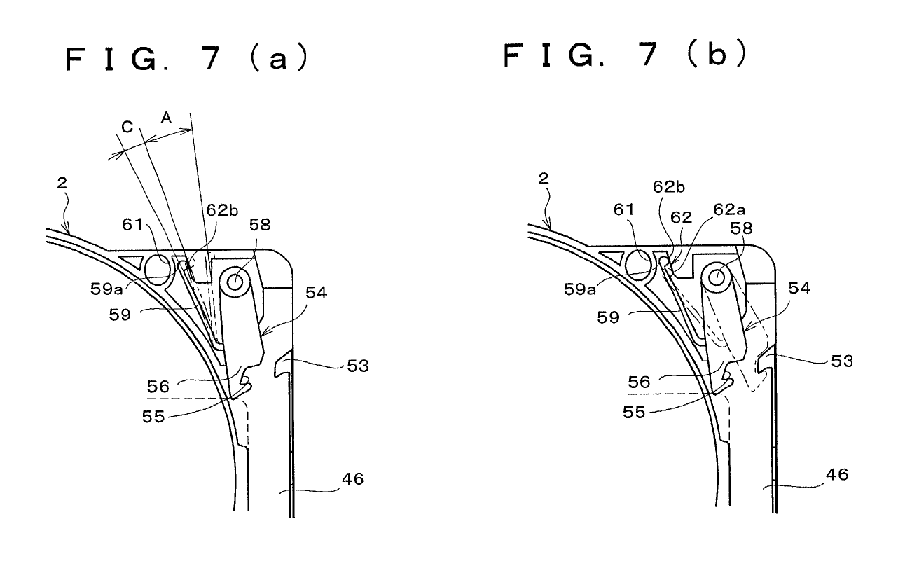

Accordingly, in the present embodiment, as shown in FIG. 7(a), the angle that the pressing spring 59 makes with the disengaged lever section 56 is specified to be equal to a sum of the initial angle A which is the displacement caused by the initial pressing force when the lever section 56 is engaged with the shutter 47 and a rotation angle C which is less than half the rotation angle B made by the position of the lever section 56 engaged with the shutter 47 and the position of the lever section 56 not engaged with the shutter 47. Besides, the spring section contact wall 62 of the cartridge 2 is formed so that the protuberance 59a of the pressing spring 59 can remain in a position 62b.

FIG. 7(b) shows, in this structure, the lever section 56 in engagement with the shutter lock engagement bump 53 with the alternate long and two short dashes. Therefore, in the present embodiment, the angle of the spring section contact wall 62 of the cartridge 2 is specified to be equal to that linking the position 62a to the position 62b to maintain the foregoing relationship and is substantially perpendicular to the front of the cartridge 2 in terms of the insertion direction. Therefore, the protuberance 59a of the pressing spring 59 is displaced on the spring section contact wall 62.

Consequently, using the pressing spring 59 of the present embodiment, the pressing force of the pressing spring 59 when the lever section 56 is not engaged can be kept lower than in conventional cases, and the stress the pressing spring 59 exerts on the lever section 56 can be kept low. Specifically, assume that the initial angle A≈15° to produce the initial pressing force, the rotation angle B≈19°, A+B≈34°, and the rotation angle C≈5°. In this case, when in no engagement, the angle X=A+C≈20°. The value of the angle X when in no engagement is about 60% that in conventional cases. The stress is thus reduced by more than 40%. The rotation angle C is preferably less than half the rotation angle B to produce tangible effects of reduced stress.

To put the reasoning other way round, this indicates that the protuberance 59a of the pressing spring 59 can be disposed close to the rotation support point 58 of the lever section 56. As a result, to set aside room to accommodate a magnetic head supporting angle (not shown) linking the magnetic head 12 to the pickup unit 7, also in the cartridge 2 having a positioning hole 61 at the front in terms of the insertion direction, without having to moving the pressing spring 59 toward it, the pressing spring 59 can be caused to be in a condition to ensure a required pressing force and accommodated on a small, triangular corner.

As detailed above, in the disk cartridge of the present embodiment, the lock lever 54 has (i) the lever engagement recess 55 to engage with the shutter 47 near a side face of the cartridge 2 and (ii) the rotatable lever section 56 including the rotation support point 58 which is closer to the middle front part of the cartridge 2 in terms of the insertion direction than is the lever engagement recess 55. Besides, the lever section 56 is equipped with the pressing spring 59 which pushes and rotates so that the lever section 56 can engage with the shutter 47.

Therefore, when the disk cartridge is not loaded in the optical disk read/write device, the lock lever 54 is in engagement with the lever engagement recess 55 on the lever section 56 and interlocks the shutter lock engagement bump 53 of the shutter 47 near a side face of the cartridge 2. The shutter 47 has the first window 41, the second window 43, and the third window 44 closed.

To load the cartridge 2 into the optical disk read/write device in this condition, insert the cartridge 2 into the optical disk read/write device. The insertion of the cartridge 2 into the optical disk read/write device disengages the shutter lock engagement bump 53 of the shutter 47 from the lever engagement recess 55 of the lever section 56. As the cartridge 2 is inserted deeper into the optical disk read/write device, the shutter 47 slides in an opposite direction to the insertion direction and causes the first window 41, the second window 43, and the third window 44 to allow the magnetic head 12 and pickup unit 7 to read/write data on the magneto-optical disk 1 contained in the cartridge 2.

In the present embodiment, the pressing spring 59 is rooted at the lever section 56, opposite the lever engagement recess 55, between the lever engagement recess 55 and the rotation support point 58 and extends from there towards and past the rotation support point 58.

The pressing spring 59 is rooted, at one of its ends, at the lever section 56, opposite the lever engagement recess 55, between the lever engagement recess 55 and the rotation support point 58. The pressing spring 59 presses, at an end thereof, somewhere between the lever engagement recess 55 and the rotation support point 58 of the lever section 56 and therefore can apply a rotational moment to the lever section 56 efficiently, compared to the pressing spring 59 pressing somewhere close to the rotation support point 58 of the lever section 56.

Extending past the rotation support point 58 at the other end, the pressing spring 59 has an extended length L compared to a pressing spring 59 extending only up to the rotation support point 58 of the lever section 56. This allows for a reduced stress σ of the pressing spring 59 when the lever section 56 releases the shutter 47.

Meanwhile, the pressing spring 59 is rooted at the lever section 56, opposite the lever engagement recess 55, between the lever engagement recess 55 and the rotation support point 58 to extend the rotation support point 58. The rotation support point 58 of the lever section 56 is situated closer to the middle front part of the cartridge 2 in terms of the insertion direction than is the lever engagement recess 55. Owning to this, the pressing spring 59 does not have to form a large angle with the lever section 56, which in turn facilitates suitable arrangement of the pressing spring 59 on a triangular corner on a side face of the cartridge 2 near its front in terms of the insertion direction.

Consequently, a disk cartridge is now available in which the pressing spring 59 can be mounted in small space on the triangular corner and with which the pressing spring 59 of the lock lever 54 can be kept low.

Meanwhile, in conventional cases, the pressing force the spring section exerts on the lever section is equal to a sum of an initial pressing force when the lever section is engaged with the shutter and a pressing force caused by the rotation angle of the lever section when the lever section is not engaged with the shutter.

Nevertheless, if a pressing force caused by the rotation angle of the lever section when the lever section is not engaged with the shutter is applied using a short spring section, the lever section receives excessively strong pressing stress, and the spring section experiences excessively high tension when not engaged, which is not suitable.

Accordingly, in the present embodiment, the protuberance 59a at the tip of the pressing spring 59 of the lock lever 54 is displaced on the spring section contact wall 62, of the cartridge 2, which is for receiving the protuberance 59a of the pressing spring 59 of the lock lever 54. In addition, the angle of the spring section contact wall 62, of the cartridge 2, which is for receiving the protuberance 59a of the pressing spring 59 is equal to an angle between (i) the position 62a of the pressing spring 59 of the lock lever 54 being displaced by an amount equivalent to a predetermined load when the lock lever 54 is engaged with the shutter 47 and (ii) the position 62b when the lock lever 54 is not engaged, the position 62b being an addition of the initial angle A such that the angle of the pressing spring 59 is the same displacement angle as during engagement to the rotation angle C which is less than half the rotation angle B by which the lock lever 54 is displaced.

Therefore, the protuberance 59a of the pressing spring 59 is displacement on the spring section contact wall 62, as well as changes the angle of the spring section contact wall 62 receiving the protuberance 59a of the pressing spring 59.

This reduces, in comparison to conventional cases, the pressing stress, and hence the tension, of the pressing spring 59 when the lever section 56 is not engaged with shutter 47.

Besides, as to space, for example, even if the positioning hole 61 is located at the front of the cartridge 2 in terms of the insertion direction to provide a magnetic head supporting angle to connect the magnetic head 12 and the pickup unit 7, the pressing spring 59 can be placed on a triangular corner on a side face of the cartridge 2 near the front in terms of the insertion direction without the pressing spring 59 adversely affecting there in terms of location.

This ensures that the stress of the pressing spring 59 of the lock lever 54 is restrained and also that a disk cartridge can be offered in which the pressing spring 59 is located in small space on the triangular corner.

Further, in the disk cartridge of the present embodiment, the pressing spring 59 is formed so that the tip thereof is movable, and the cartridge 2 is provided with a regulator, such as the spring section contact wall 62, for regulating the movement.

Further, in the disk cartridge of the present embodiment, the spring section contact wall 62 is such that the disengagement angle X between the lever section 56 and the pressing spring 59 when the lock lever 54 is not engaged is smaller than angle A+B, where A is an initial angle between the lever section 56 and the pressing spring 59 when the lock lever 54 is not engaged and B is a rotation angle by which the lock lever 54 is displaced when the lock lever 54 disengages.

Further, in the disk cartridge of the present embodiment, the disengagement angle X is smaller than (Initial Angle A)+(½)×(Rotation Angle B).

For these reasons, the stress, σ, of the pressing spring 59 can be kept small when the lever section 56 is not engaged with the shutter 47.

Further, in the disk cartridge of the present embodiment, the pressing spring 59 is equipped at the tip thereof with the protuberance 59a as a sliding section. The provision of the protuberance 59a permits the pressing spring 59 to easily slide on the spring section contact wall 62.

Further, in the disk cartridge of the present embodiment, the pressing spring 59 is adapted so that the pressing force the pressing spring 59 exerts on the lever section 56 when the lock lever 54 is released from engagement with the shutter 47 is smaller than the pressing force caused by a change in the angle between the pressing spring 59 and the lever section 56 by the rotation angle B by which the lock lever 54 is displaced when the lock lever 54 is released from engagement. Consequently, the pressing stress a, and hence the tension, of the pressing spring 59 when the lever section 56 is not engaged with the shutter 47 are smaller than those in conventional cases.

In the present embodiment, the regulator is composed of the spring section contact wall 62; this is not the only option. For example, the regulator may be, instead, composed of a support pillar provided to the upper shell 40 or the lower shell 42.

[Embodiment 2]

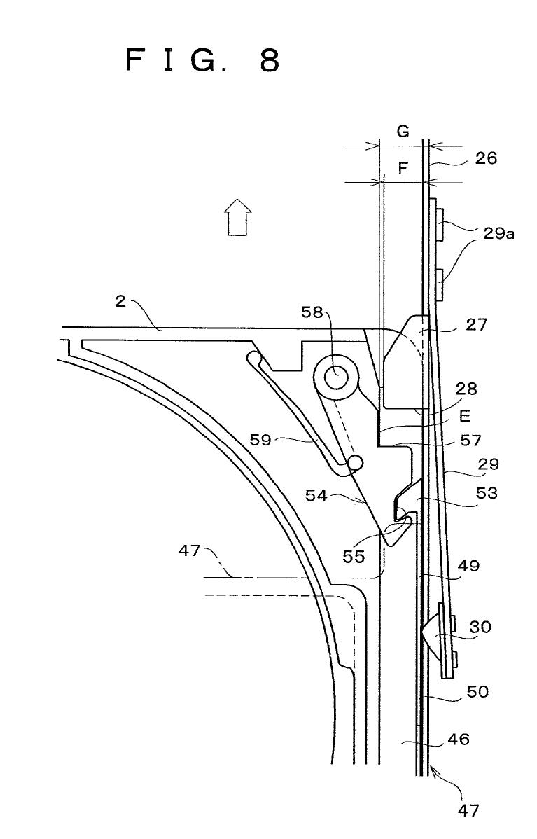

In reference to FIGS. 8-10, the following will describe another embodiment of the present invention. Here, for convenience, members of the present embodiment that have the same arrangement and function as members of embodiment 1, and that are mentioned in that embodiment are indicated by the same reference numerals and description thereof is omitted.

In the present embodiment, as shown in FIG. 8, a lock lever contact surface 57, which is part of a lock lever 54 where the lock lever 54 contacts an unlocking member 27, is perpendicular to the insertion direction of the cartridge 2. Accordingly, an unlocking member contact surface 28, of the unlocking member 27, which contacts the lock lever contact surface 57 is parallel to the lock lever contact surface 57. This ensures a firm contact between the two as will be detailed later.

Under these conditions, the lock lever 54 of the present embodiment has a rotation support point 58 inside the cartridge-side groove 46 on the side face of the cartridge 2 near the front in terms of the insertion direction. Consequently, even if the lock lever contact surface 57 and the unlocking member contact surface 28 contact perpendicularly to the insertion direction of the cartridge 2, the lock lever 54 can turn around the rotation support points 58 owing to force division toward the interior.

Further, in the present embodiment, as shown in the figure, a parallel face E of the lock lever 54 is located inside a depth, G, of the cartridge-side groove 46. Strictly, it is suffice if the parallel face E of the lock lever 54 is located inside an inner protrusion dimension F of the unlocking member 27 of the cartridge holder 26 moving in the cartridge-side groove 46. This causes the unlocking member 27 to remain out of contact with the parallel face E of the lock lever 54 when the cartridge 2 is inserted, until and even after the unlocking member 27 comes in contact with the lock lever contact surface 57.

An operation will be now described to insert the cartridge 2 into the cartridge holder 26.

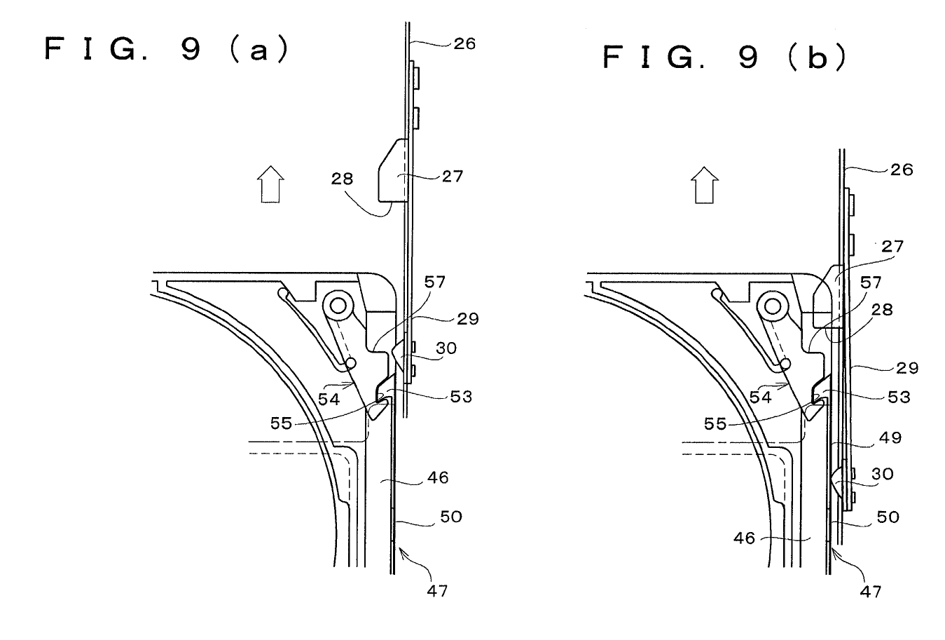

Referring to FIGS. 4(a) and 4(b), the cartridge 2 is inserted with the cartridge holder 26 lifted from the main chassis 3. In this case, as shown in FIG. 9(a), first, the shutter-moving protuberance 30 disposed at the front end, in terms of the insertion direction, of the resilient shutter mover 29 which is provided to the cartridge holder 26 to open/close the shutter 47 moves into the cartridge-side groove 46 formed on a side face of the cartridge 2 and then moves and slides on the perpendicular surface 49 of the shutter 47 as shown in FIG. 9(b).

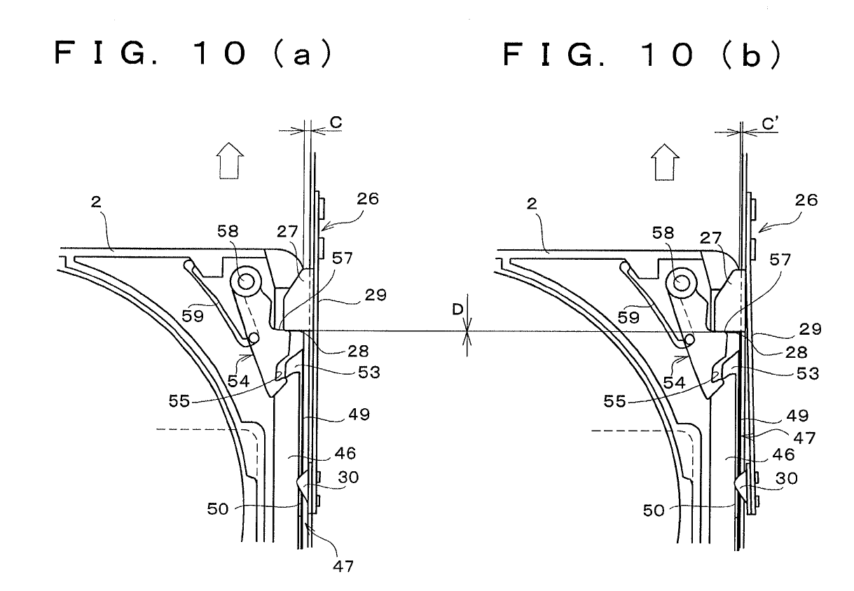

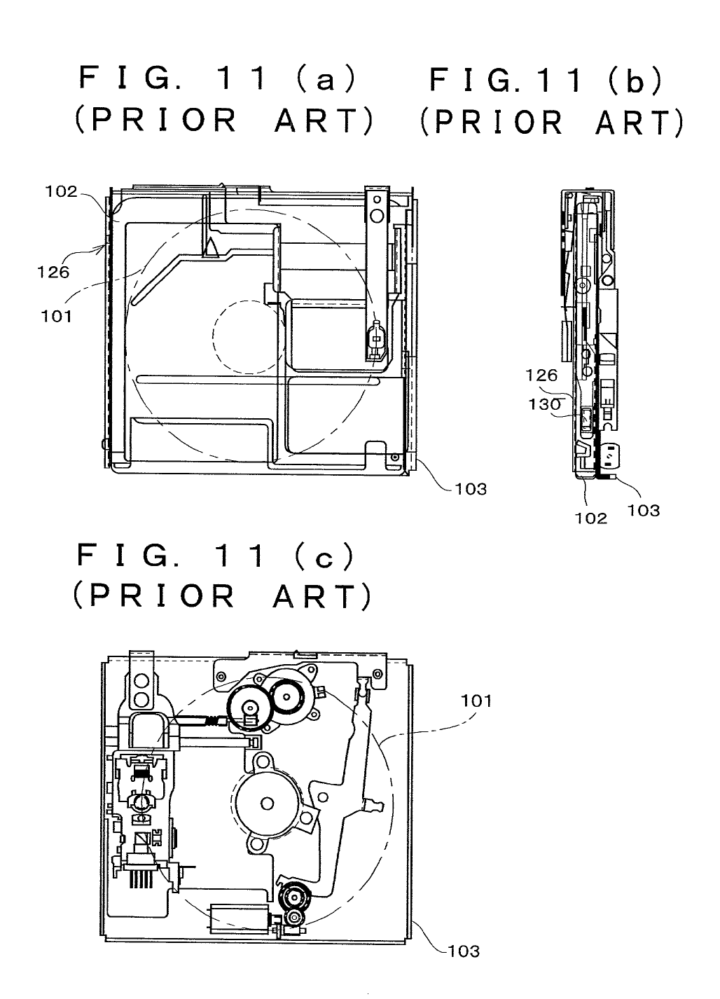

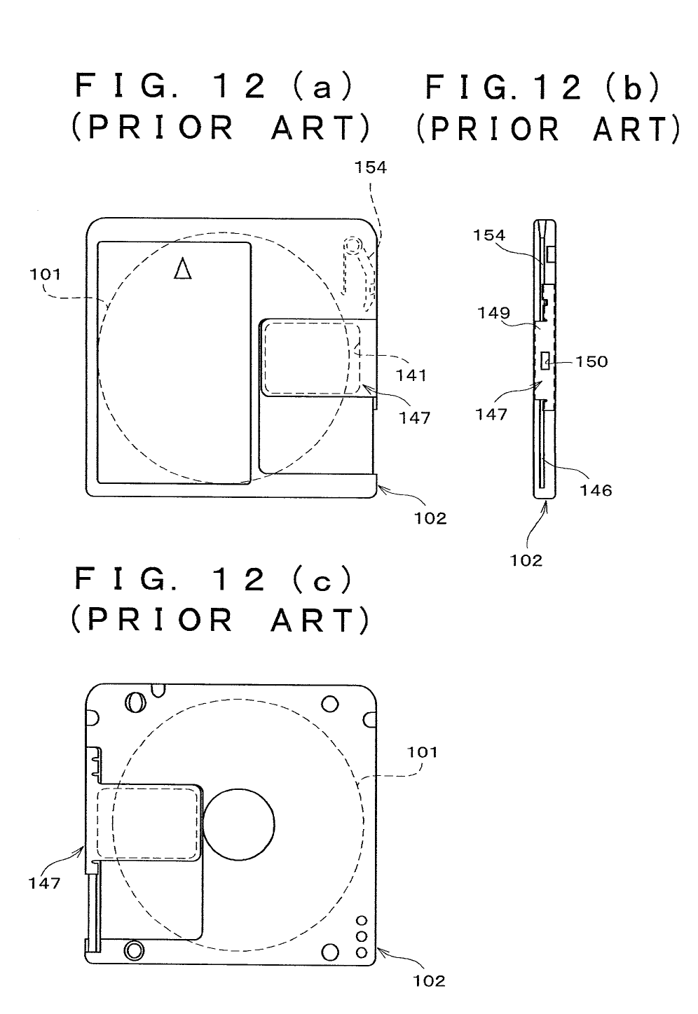

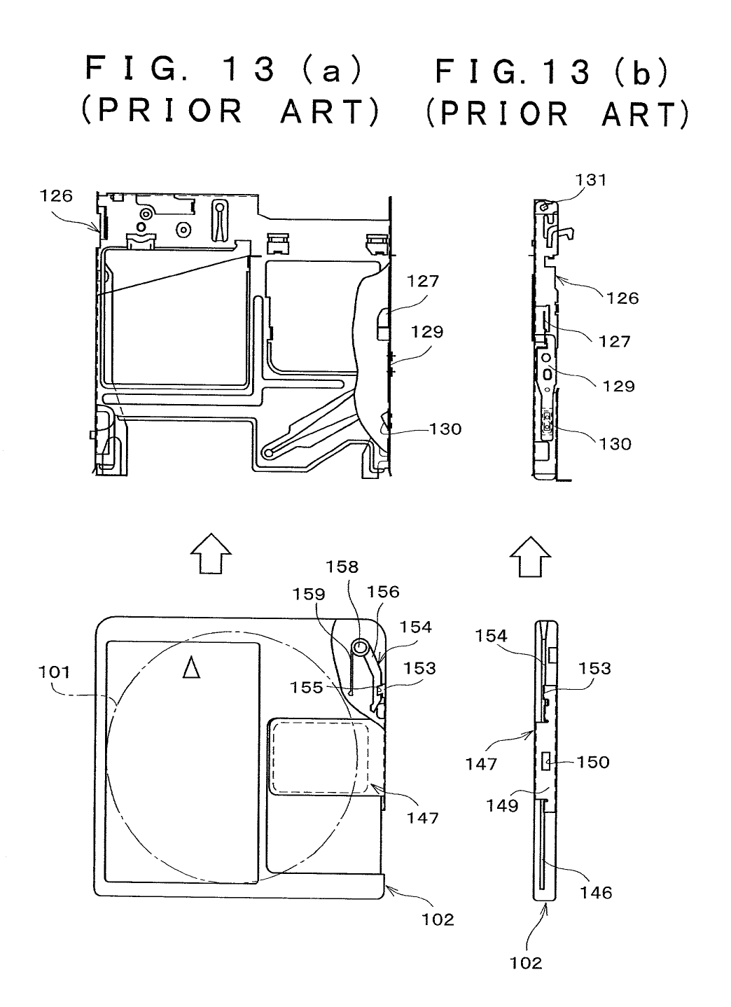

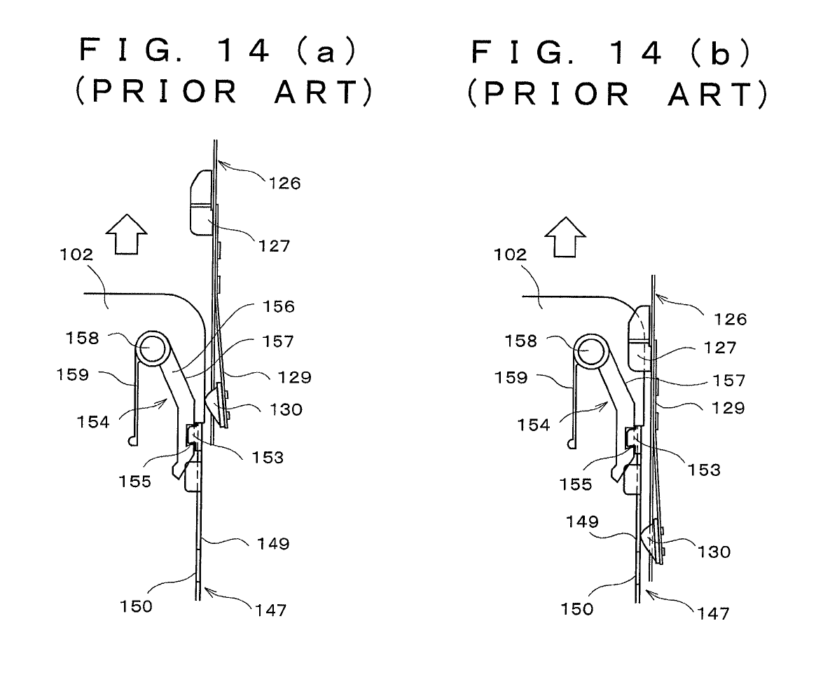

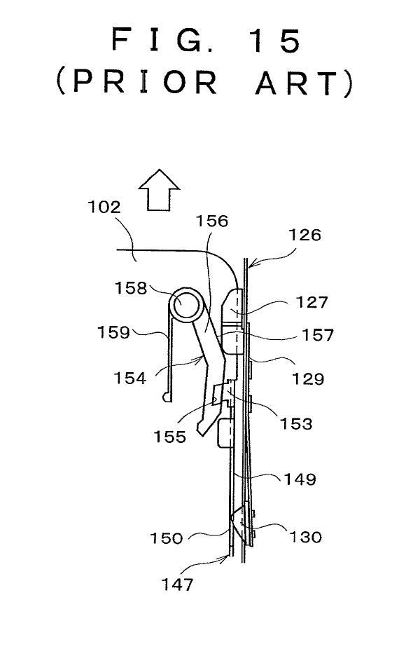

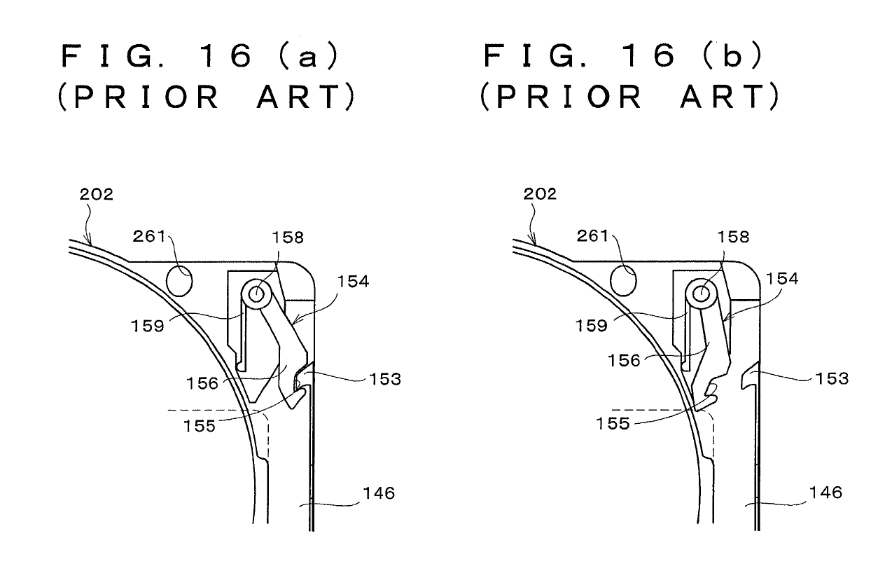

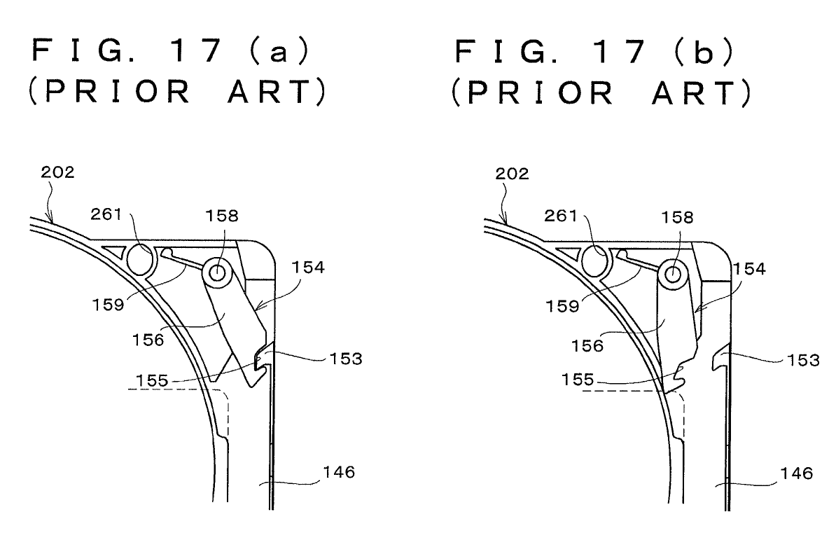

Thereafter, as shown in FIG. 10(a), the unlocking member contact surface 28 of the unlocking member 27 formed on the cartridge holder 26 comes with contact with a lock lever contact surface 57 of the lock lever 54 of the cartridge 2; thus, the lock lever 54 rotates around the rotation support point 58, and the lock lever engagement recess 55 of the lock lever 54 disengages from the shutter lock engagement bump 53 of the shutter 47.

As the cartridge 2 is inserted deeper, the unlocking member 27 moves into contact with the front of the shutter lock engagement bump 53 of the shutter 47 in terms of the insertion direction.

Simultaneously with the unlocking member 27 moving into contact with the shutter 47, the shutter-moving protuberance 30 disposed at the front of the shutter mover 29 in terms of the insertion direction enters, by means of a resilient force, the shutter window section 50 carved out on the perpendicular surface 49 and thus holds the shutter 47 at a predetermined part of the cartridge holder 26.

By the push operation of the cartridge 2, the cartridge 2 itself is pushed deep inside, but the shutter 47 is held in the original position; the relative movement causes the shutter 47 to open.

Conversely, to close the shutter 47, the cartridge 2 is pulled in a direction opposite to the insertion direction; the shutter 47 does not move for a while because the shutter-moving protuberance 30 is engaged with the shutter window section 50 of the shutter 47. As the shutter 47 closes the cartridge 2, the unlocking member 27 is released from the shutter 47, the lock lever 54 soon interlocks with the shutter 47, the shutter-moving protuberance 30 moves over from the shutter window section 50 of the shutter 47, and thereafter, the cartridge 2 is completely pulled out of the cartridge holder 26.

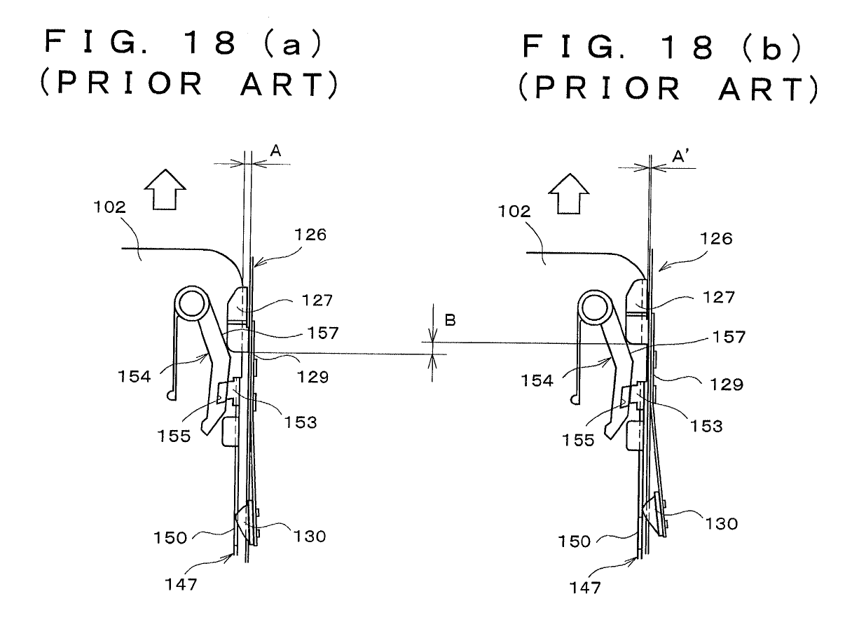

In the above arrangement and insertion operation, conventional cases have problems: as shown in FIGS. 18(a) and 18(b), the lock lever 154 contacts the unlocking member 127 on a slanting face, and the shutter 147 is unlocked at a variable position.

In contrast, in the present embodiment, as shown in FIGS. 10(a) and 10(b), the lock lever contact surface 57 of the lock lever 54 where the lock lever 54 comes in contact with the unlocking member 27 is perpendicular to the insertion direction of the cartridge 2. The width of the cartridge holder 26 (as measured perpendicularly to the insertion direction), as a result, becomes greater than the width of the cartridge 2. For example, even if the relative dimensional positions of the lock lever 54 and the unlocking member 27 in a direction perpendicular to the insertion direction which are originally as wide as C as shown in FIG. 10(a) decrease to C′ as shown in FIG. 10(b), the position of the lock lever contact surface 57 comes in contact at the original position in terms of the insertion direction as indicated by D in FIGS. 10(a) and 10(b); therefore, the unlocking timings remain substantially unchanged.

Besides, referring to FIG. 8, since the parallel face E of the lock lever 54 is located inside the inner protrusion dimension F of the unlocking member 27 of the cartridge holder 26, the unlocking member 27 never contacts the lock lever 54 before contacting the lock lever contact surface 57. Thus, it is ensured that the unlocking member 27 first contacts the lock lever contact surface 57 of the lock lever 54.

Further, since the unlocking member 27 is brought into contact with a perpendicular surface of the lock lever 54 as detailed in the foregoing, the unlocking position can be moved closer to the lock lever 54, that is, the position of the lock lever engagement recess 55 can be moved closer to the lock lever contact surface 57. Therefore, by doing so, the shutter-moving protuberance 30 can be securely caught by the shutter window section 50 before unlocking, and the shutter 47 does not fail to open.

The disk cartridge of the present embodiment, as detailed in the foregoing, includes: the magneto-optical disk 1 on which data is written; the cartridge 2 containing the magneto-optical disk 1 in a rotatable manner and having the first window 41, the second window 43, and the third window 44 through which the pickup unit 7 of the optical disk read/write device makes internal access; the shutter 47 which slides parallel to the direction in which the cartridge 2 is inserted into the optical disk read/write device, so as to open/close the first window 41, the second window 43, and the third window 44; and the rotatable lock lever 54 having the rotation support point 58 inside the cartridge-side groove 46 formed on a side face of the cartridge 2 near the front in terms of the insertion direction to engage with, and thus secures, the shutter 47 when the shutter 47 closes.

Additionally, in the present embodiment, the cartridge 2 is adapted so that the lock lever 54 is formed facing inwards on a side face of the cartridge holder 26 of the optical disk read/write device and that the lock lever contact surface 57 which contacts the unlocking member 27 to unlock the lock lever 54 from the engagement with the shutter 47 when the cartridge 2 is inserted has a face perpendicular to the insertion direction of the cartridge.

In conventional cases, if the relative positions of the cartridge 2 and the unlocking member 27 of the cartridge holder 26 in a direction perpendicular to the insertion direction of the cartridge varies, the timing to unlock the shutter 47 also varies due to the slanting contact surface between the lock lever 54 and the unlocking member 27, causing the shutter 47 fail to open. In contrast, in the present embodiment, the lock lever contact surface 57 is provided with a face perpendicular to the insertion direction of the cartridge, and the shutter 47 therefore is unlocked at a substantially invariable timing.

Consequently, a disk cartridge can be offered which ensures, regardless of the insertion condition of the cartridge 2, that the shutter 47 is unlocked and the shutter 47 is opened/closed appropriately.

Further, in the disk cartridge of the present embodiment, the lock lever 54 is adapted so that when the shutter 47 is closed, the position of a side face which is opposite to the unlocking member and closer to the front in terms of the insertion direction than is the lock lever contact surface 57, that is, the parallel face E, is inside the depth position of the unlocking member 27 inserted into the cartridge-side groove 46 formed on a side face of the cartridge 2.

This does not allow, when the cartridge 2 is to be inserted into the cartridge holder 26, the unlocking member 27 to contact the parallel face E which is a side face opposite to the unlocking member 27 closer to the front in terms of the insertion direction than is the lock lever contact surface 57 before the unlocking member 27 contacts the lock lever contact surface 57. In other words, the unlocking member 27 only contacts the lock lever contact surface 57 when the cartridge 2 is to be inserted into the cartridge holder.

It is thereby ensured that the shutter 47 is prevented from being unlocked at a variable timing.

Consequently, a disk cartridge can be offered which ensures, regardless of the insertion condition of the cartridge 2, that the shutter 47 is unlocked and the shutter 47 is opened/closed appropriately.

Further, in the disk cartridge of the present embodiment, the lock lever 54 is adapted so that when the shutter 47 is closed, the position of a side face which is opposite to the unlocking member and closer to the front in terms of the insertion direction than is the lock lever contact surface 57, that is, the parallel face E is inside the depth, G, of the cartridge-side groove 46.

This does not allow, when the cartridge 2 is to be inserted into the cartridge holder 26, the unlocking member 27 to contact the parallel face E which is a side face opposite to the unlocking member 27 closer to the front in terms of the insertion direction than is the lock lever contact surface 57 before the unlocking member 27 contacts the lock lever contact surface 57. In other words, the unlocking member 27 only contacts the lock lever contact surface 57 when the cartridge 2 is to be inserted into the cartridge holder 26.

It is thereby ensured that the shutter 47 is prevented from being unlocked at a variable timing.

Consequently, a disk cartridge can be offered which ensures, regardless of the insertion condition of the cartridge 2, that the shutter 47 is unlocked and the shutter 47 is opened/closed appropriately.

Further, in the disk cartridge of the present embodiment, the shutter 47 is provided with (i) the shutter window section 50 carved out for engagement with the shutter-moving protuberance 30 of the cartridge holder 26 so that the shutter 47 slides and opens/closes in accordance with an insertion operation of the cartridge 2 into the cartridge holder 26 and (ii) the lock lever 54 so that the shutter-moving protuberance 30 is caught in the shutter window section 50 when the unlocking member 27 of the cartridge holder 26 is in contact with the lock lever contact surface 57.

The lock lever 54 can thereby be released from engagement with the shutter 47 after the shutter-moving protuberance 30 is caught by the shutter window section 50, and the shutter 47 can be surely opened.

Consequently, a disk cartridge can be offered which ensures, regardless of the insertion condition of the cartridge 2, that the shutter 47 is unlocked and the shutter 47 is opened/closed appropriately.

Further, in the optical disk read/write device of the present embodiment, the unlocking member contact surface 28, where the unlocking member 27 contacts the lock lever 54, is formed substantially parallel to the lock lever contact surface 57 to load the disk cartridge.

This ensures that the unlocking member 27 contacts the lock lever 54 in a direction perpendicular to the insertion direction of the cartridge.

Consequently, an optical disk read/write device can be offered which ensures, regardless of the insertion condition of the cartridge 2, that the shutter 47 is unlocked and the shutter 47 is opened/closed appropriately.

Further, in the optical disk read/write device of the present embodiment, the unlocking member 27 is adapted to remain out of contact from a side face of the lock lever 541 that is, the parallel face E until the unlocking member 27 comes in contact with the lock lever contact surface 57 to load the disk cartridge.

This does not allow, when the cartridge 2 is to be inserted into the cartridge holder 26, the unlocking member 27 to contact a side face of the lock lever 54, that is, the parallel face E, before the unlocking member 27 contacts the lock lever contact surface 57. In other words, the unlocking member 27 only contacts the lock lever contact surface 57 when the cartridge 2 is to be inserted into the cartridge holder 26.

It is thereby ensured that the shutter 47 is prevented from being unlocked at a variable timing.

Consequently, an optical disk read/write device can be offered which ensures, regardless of the insertion condition of the cartridge 2, that the shutter 47 is unlocked and the shutter 47 is opened/closed appropriately.

Further, in the optical disk read/write device of the present embodiment, to load the disk cartridge, the unlocking member 27 is adapted so that the depth position of the unlocking member 27 inserted into the cartridge-side groove 46 formed on a side face of the cartridge 2 is outside the position of the parallel face E which is a side face opposite to the unlocking member 27 which is closer to the front in terms of the insertion direction than is the lock lever contact surface 57 when the shutter 47 is closed.

This does not allow, when the cartridge 2 is to be inserted into the cartridge holder 26, the unlocking member 27 to contact the parallel face E before the unlocking member 27 contacts the contact surface of the lock lever contact surface 57. In other words, the unlocking member 27 only contacts the lock lever contact surface 57 when the cartridge 2 is to be inserted into the cartridge holder 26.

It is thereby ensured that the shutter 47 is prevented from being unlocked at a variable timing.

Consequently, an optical disk read/write device can be offered which ensures, regardless of the insertion condition of the cartridge 2, that the shutter 47 is unlocked and the shutter 47 is opened/closed appropriately.

Further, in the optical disk read/write device of the present embodiment, the shutter-moving protuberance 30 of the cartridge holder 26 is adapted to be caught in the shutter window section 50 formed on the shutter 47 when the unlocking member 27 of the cartridge 2 is in contact with the lock lever contact surface 57 to load the disk cartridge.

The lock lever 54 can thereby be released from engagement with the shutter 47 after the shutter-moving protuberance 30 is caught by the shutter window section 50, and the shutter 47 can be surely opened.

Consequently, an optical disk read/write device can be offered which ensures, regardless of the insert condition of the cartridge 2, that the shutter 47 is unlocked and the shutter 47 is opened/closed appropriately.

Additionally, in the disk cartridge of the present invention, the tip of the spring section of the lock member can be displaced on a wall, of the cartridge, which is for receiving the tip of the spring section of the lock member, and the angle of the wall, of the cartridge, which is for receiving the tip of the spring section is specified to be equal to an angle between (i) the position of the tip of the spring section of the lock member displaced by an amount equivalent to a predetermined load when the lock member is in engagement with the shutter and (ii) the position of the tip of the spring section when the lock member is not engaged, the position being an addition of the angular displacement of the spring section when the lock member is in engagement and an angle less than half the angular displacement of the lock member.

Consequently, the pressing stress a, and hence the tension, of the pressing section when the lever section is not engaged with the shutter are smaller than those in conventional cases.

Besides, as to space, even if a positioning hole exists, the spring section can be placed on a triangular corner on a side face of the cartridge near the front in terms of the insertion direction without the spring section adversely affecting there in terms of location.

Further, in the disk cartridge of the present embodiment, the pressing spring can be formed so that the tip thereof is movable, and the cartridge can be provided with a regulator for regulating the movement.

Further, in the disk cartridge of the present embodiment, the spring section contact wall is such that the disengagement angle X between the lever section and the spring section when the lock lever is not engaged is smaller than angle A+B, where A is an initial angle between the lever section and the spring section when the lock lever is not engaged and B is a rotation angle by which the lock lever is displaced when the lock lever disengages.

Further, in the disk cartridge of the present embodiment, the disengagement angle X can be smaller than (Initial Angle A)+(½)×(Rotation Angle B).

For these reasons, the stress, σ, of the pressing spring 59 can be kept small when the lever section 56 is not engaged with the shutter 47.

For these reasons, the stress of the spring section can be kept low when the lever section is released from the engagement with the shutter.

Further, in the disk cartridge of the present embodiment, the spring section is equipped at the tip thereof with a sliding section.

The provision of the sliding section is permits the spring section to easily slide on the spring section contact wall.

Further, in the disk cartridge of the present invention, the lock member may be adapted so that when the shutter is closed, the position of a side face which is opposite to the unlocking member located closer to the front in terms of the insertion direction than is the contact surface of the unlocking member is inside the depth position of the unlocking member inserted into the cartridge-side groove formed on a side face of the cartridge.

This does not allow, when the cartridge is to be inserted into the cartridge holder, the unlocking member to contact a side face which is opposite to the unlocking member closer to the front in terms of the insertion direction than is the contact surface of the lock member before the unlocking member contacts the contact surface of the lock member. In other words, the unlocking member only contacts the contact surface of the lock member when the cartridge is to be inserted into the cartridge holder.

Consequently, it is ensured that the shutter is prevented from being unlocked at a variable timing. Consequently, a disk cartridge can be offered which ensures, regardless of the insert condition of the cartridge, that the shutter is unlocked and the shutter is opened/closed appropriately.

Further, in the disk cartridge of the present embodiment, the shutter can be provided with (i) the shutter window section carved out for engagement with the shutter-moving protuberance of the cartridge holder so that the shutter slides and opens/closes in accordance with an insertion operation of the cartridge into the cartridge holder and (ii) the lock member so that the shutter-moving protuberance is caught in the shutter window section when the unlocking member of the cartridge holder is in contact with the contact surface of the lock member.

The lock member can thereby be released from engagement with the shutter after the shutter-moving protuberance is caught by the shutter window section, and the shutter can be surely opened. Consequently disk cartridge can be offered which ensures, regardless of the insertion condition of the cartridge, that the shutter is unlocked and the shutter is opened/closed appropriately.

Further, in the optical disk read/write device of the present invention, the unlocking member can be adapted to remain out of contact from a side face of the lock member until the unlocking member comes in contact with the contact surface of the lock member to load the disk cartridge.

This does not allow, when the cartridge is to be inserted into the cartridge holder, the unlocking member to contact a contact surface of the lock member before the unlocking member contacts a side face of the lock member. In other words, the unlocking member only contacts the contact surface of the lock member when the cartridge is to be inserted into the cartridge holder.

It is thereby ensured that the shutter is prevented from being unlocked at a variable timing. Consequently, an optical disk read/write device can be offered which ensures, regardless of the insertion condition of the cartridge, that the shutter is unlocked and the shutter is opened/closed appropriately.

Further, in optical disk read/write device of the present invention, to load the disk cartridge, the unlocking member can be adapted so that the depth position of the unlocking member inserted into the cartridge-side groove formed on a side face of the cartridge is outside the position of a side face opposite to the unlocking member which is closer to the front in terms of the insertion direction than is the contact surface of the lock member where the lock member contacts the unlocking member when the shutter is closed.

This does not allow, when the cartridge is to be inserted into the cartridge holder, the unlocking member to contact a side face of the lock member before the unlocking member contacts the contact surface of the lock member. In other words, the unlocking member only contacts the contact surface of the lock member when the cartridge is to be inserted into the cartridge holder.

It is thereby ensured that the shutter is prevented from being unlocked at a variable timing. Consequently, an optical disk read/write device can be offered which ensures, regardless of the insertion condition of the cartridge, that the shutter is unlocked and the shutter is opened/closed appropriately.

Further, in the optical disk read/write device of the present invention, the shutter-moving protuberance of the cartridge holder can be adapted to be caught in the shutter window section formed on the shutter when the unlocking member of the cartridge holder is in contact with the contact surface of the lock member to load the disk cartridge.

The lock member can thereby be released from engagement with the shutter after the shutter-moving protuberance is caught by the shutter window section, and the shutter can be surely opened. Consequently, an optical disk read/write device can be offered which ensures, regardless of the insertion condition of the cartridge, that the shutter is unlocked and the shutter is opened/closed appropriately.

The invention being thus described, it will be obvious that the same may be varied in many ways. Such variations are not to be regarded as a departure from the spirit and scope of the invention, and all such modifications as would be obvious to one skilled in the art intended to be included within the scope of the following claims.

What is claimed is:

1. A disk cartridge, comprising:
a disk for storing data;
a cartridge for containing the disk in a rotatable manner, complete with a read/write window through which read/write means of an optical disk read/write device makes internal access;
a shutter which, when the cartridge is inserted into the optical disk read/write device and the read/write window is opened, slides on the cartridge in a direction opposite to a direction of the insertion as a result of the insertion; and
a lock member for engaging with the shutter to prevent the shutter from moving when the shutter is closed and disengaging from the shutter as a result of the insertion of the cartridge;
wherein
the lock member includes:
an engagement section for engaging with the shutter near a side face of the cartridge;
a lever section which rotates around a rotation support point which is located closer to a middle front part of the cartridge in terms of the direction of the insertion than is the engagement section; and
a spring section, rooted at the lever section, opposite the engagement section, between the engagement section and the rotation support point to extend towards and past the rotation support point, for pressing the lever section to apply thereto a rotational force in such a direction that the lever section can engage with the shutter.

2. The disk cartridge as set forth in claim 1, wherein:
a tip of the spring section of the lock member is displaced on a wall, of the cartridge, for receiving the tip of the spring section of the lock member;
an angle of the wall, of the cartridge, for receiving the tip of the spring section is specified equal to an angle between (i) a position of a tip of the spring section of the lock member displaced by an amount equivalent to a predetermined load when the lock member is in engagement with the shutter and (ii) a position of the tip of the spring section when the lock member is not in engagement, the position being an addition of an angular displacement of the spring section when the lock member is in engagement and an angle less than half the angular displacement of the lock member.

3. The disk cartridge as set forth in claim 1, wherein:
the tip of the spring section is provided in a movable manner; and
the cartridge has a regulator section for regulating movement of the tip.

4. The disk cartridge as set forth in claim 3, further comprising a sliding section provided on the tip of the spring section.

5. The disk cartridge as set forth in claim 3, wherein the regulator section satisfies an equation:
X<A+B
where X is an angle between the lever section and the spring section when the lock member is not in engagement, A is an angle between the lever section and the spring section when the lock member is in engagement, and B is an angle by which the lock member is displaced when the lock member is released from engagement.

6. The disk cartridge as set forth in claim 5, further comprising a sliding section provided on the tip of the spring section.

7. The disk cartridge as set forth in claim 5, wherein
X<A+(½)×B.

8. The disk cartridge as set forth in claim 7, further comprising a sliding section provided on the tip of the spring section.

9. A disk cartridge, comprising:
a disk for storing data;
a cartridge for containing the disk in a rotatable manner, complete with a read/write window through which read/write means of an optical disk read/write device makes internal access;
a shutter which, when the cartridge is inserted into the optical disk read/write device and the read/write window is opened, slides on the cartridge in a direction opposite to a direction of the insertion as a result of the insertion; and
a lock member for engaging with the shutter to prevent the shutter from moving when the shutter is closed and disengaging from the shutter as a result of the insertion of the cartridge;
wherein
the lock member includes:
an engagement section for engaging with the shutter near a side face of the cartridge;
a lever section which rotates around a rotation support point which is located closer to a middle front part of the cartridge in terms of the direction of the insertion than is the engagement section; and
a spring section for pressing the lever section to apply thereto a rotational force in such a direction that the lever section can engage with the shutter, the spring section being adapted so that a pressing force applied to the lever section by the spring section as a result of the lock member being released from the engagement with the shutter is smaller than a pressing force applied as a result of a change in an angle between the spring section and the lever section, the change being equal to an angle by which the lock member is displaced when the lock member is released from the engagement.

10. A disk cartridge, comprising:
a disk for storing data;
a cartridge for containing the disk in a rotatable manner, complete with a read/write window through which read/write means of an optical disk read/write device makes internal access;
a shutter which slides parallel to a direction of insertion of the cartridge into the optical disk read/write device to open/close the read/write window; and
a lock member for engaging with the shutter to prevent the shutter from moving when the shutter is closed and rotating around a rotation support point provided inside a cartridge-side groove formed on a side face of the cartridge near a front of the cartridge in terms of the direction of insertion,
wherein
the lock member of the cartridge is provided facing inwards on a side face of a cartridge holder in the optical disk read/write device and is adapted so that a contact surface where the lock member contacts an unlocking member for releasing the lock member from the engagement with the shutter when the cartridge is inserted has a perpendicular surface in the direction of the insertion of the cartridge.

11. The disk cartridge as set forth in claim 10, wherein:
the shutter has a shutter window section carved out for engaging with a shutter-moving protuberance of the cartridge holder as a result of insertion of the cartridge into the cartridge holder to cause the shutter to slide and open/close; and
the lock member is adapted so that the shutter-moving protuberance is caught in the shutter window section when the unlocking member of the cartridge holder is in contact with the contact surface of the lock member.

12. The disk cartridge as set forth in claim 10, wherein
the lock member is disposed so that when the shutter is closed, the position of a side face opposite the unlocking member which is located closer to a front in terms of the direction of the insertion than is the contact surface for the unlocking member is inside a depth position of the unlocking member inserted in the cartridge-side groove formed on a side face of the cartridge.

13. The disk cartridge as set forth in claim 12, wherein:
the shutter has a shutter window section carved out for engaging with a shutter-moving protuberance of the cartridge holder as a result of insertion of the cartridge into the cartridge holder to cause the shutter to slide and open/close; and
the lock member is adapted so that the shutter-moving protuberance is caught in the shutter window section when the unlocking member of the cartridge holder is in contact with the contact surface of the lock member.

14. An optical disk read/write device in which the disk cartridge as set forth in claim 10 is loaded, wherein
a part of the unlocking member where the unlocking member contacts the lock member is provided substantially parallel to the contact surface of the lock member.

15. An optical disk read/write device in which the disk cartridge as set forth in claim 11 is loaded, wherein
the shutter-moving protuberance of the cartridge holder is adapted so as to be caught in the shutter window section carved out of the shutter when the unlocking member of the cartridge holder is in contact with the contact surface of the lock member.

16. An optical disk read/write device in which the disk cartridge as set forth in claim 12 is loaded, wherein
the unlocking member is adapted so as to remain out of contact from a side face of the lock member until the unlocking member contacts the contact surface of the lock member.

17. An optical disk read/write device in which the disk cartridge as set forth in claim 12 is loaded, wherein
the unlocking member is adapted so that when the shutter is closed, the depth position of the unlocking member inserted in the cartridge-side groove formed on a side face of the cartridge is outside the position of a side face opposite the unlocking member which is located closer to a front in terms of the direction of the insertion than is the contact surface of the lock member for the unlocking member.

18. An optical disk read/write device in which the disk cartridge as set forth in claim 13 is loaded, wherein
the shutter-moving protuberance of the cartridge holder is adapted so as to be caught in the shutter window section carved out of the shutter when the unlocking member of the cartridge holder is in contact with the contact surface of the lock member.
